(19) United States
(12) Patent Application Publication
(10) Pub. No.: US 2016/0091095 A1
(43) Pub. Date: Mar. 31, 2016

(54) Diaphragm Air Seal

(71) Applicant: Caterpillar Global Mining LLC, Oak Creek, WI (US)

(72) Inventors: Matthew J. Orvedahl, Racine, WI (US); Scott T. Scheffen, Milwaukee, WI (US)

(21) Appl. No.: 14/500,380

(22) Filed: Sep. 29, 2014

(51) Int. Cl. F16J 15/52

(52) U.S. Cl. CPC F16J 15/52

(57) ABSTRACT

The present disclosure is directed to a diaphragm air seal providing a seal between a cylindrical housing, such as an axle box, and a cylindrical body, such as a fraction motor, disposed within the cylindrical housing. The diaphragm air seal may include a first flange having a first sealing surface sealingly engaging the cylindrical housing, a second flange having a second sealing surface sealingly engaging the traction motor, and an air seal body extending between the flanges. The air seal body may be formed from an elastomeric material and have an S-shaped transverse cross-section. An assembly may include the diaphragm air seal and may further include an air seal weldment having a radial weldment flange and an axial weldment flange extending axially outwardly from the radial weldment flange so that the first flange of the diaphragm air seal may be disposed on and sealingly engaging the radial weldment flange.

### TECHNICAL FIELD

The present disclosure relates generally to seals and, more particularly, to a seal assembly including a diaphragm air seal for limiting air circulation between a hollow cylindrical housing and a cylindrical body disposed therein.

### BACKGROUND

Diaphragm seals are used in many applications where a cylindrical body is installed within a hollow cylindrical or tubular housing, and it is desired to retain a fluid such as air or lubricant on one side of the seal. Diaphragm seals may also be used to prevent material on one side of the seal, such as dirt, sand or other abrasive material in the surrounding environment, from entering an area where the material may cause damage to the components of the system. In many applications, the cylindrical body or the cylindrical housing rotate relative to each other about a common longitudinal axis. For example, a drive shaft may rotate within a bushing or other type of cylindrical housing. In such applications, the interface and seal between the diaphragm seal and one or both of the cylindrical body and the cylindrical housing must allow relative rotation between the seal and the interfacing component. Examples of such diaphragm seals are shown and described in U.S. Pat. No. 4,968,044 issued to Petrak on Nov. 6, 1990, U.S. Pat. No. 8,336,887 issued to Petrak on Dec. 25, 2012 and U.S. Pat. No. 8,500,130 issued to Sedlar et al. on Aug. 6, 2013.

Implementations of cylindrical bodies disposed within cylindrical housings also exist where the body and housing do not rotate relative to each other, but it is still desirable to employ a diaphragm seal to partition the space between an outer surface of the cylindrical body and an inner surface of the cylindrical housing. For example, a cylindrical axle box of a work machine or piece of excavation equipment may house a traction motor having an output drive shaft to provide power to fraction devices of the machine or equipment. While the shaft may rotate relative to a cylindrical motor body of the traction motor and to the axle box, the cylindrical motor body may be fixed relative to and approximately coaxially aligned within the axle box. To prevent overheating of the traction motor, it may be desirable to install an air seal to form an inlet or high pressure cavity in which the air surrounding the motor body and produced as the rotor rotates relative to the stator flows through the traction motor instead of around the cylindrical motor body and thereby cool the traction motor. In some current applications, an air seal is formed with a three piece steel ring design that incorporates a foam member compressed between the axle box and the traction motor to seal the high pressure cavity. Such designs may present challenges during assembly because the three rings must be positioned around the traction motor after the traction motor is installed in the axle box. In view of this, a need exists for an improved design for an air seal for installation between a cylindrical housing and a cylindrical body.

### SUMMARY OF THE DISCLOSURE

In one aspect of the present disclosure, a diaphragm air seal for providing a seal between an outer cylindrical housing and a traction motor disposed therein is disclosed. The diaphragm air seal may include a first flange having a first sealing surface for sealingly engaging with the outer cylindrical housing, a second flange having a second sealing surface for sealingly engaging with the traction motor, and an air seal body extending between the first flange and the second flange, the air seal body being formed from an elastomeric material and having an S-shaped transverse cross-section.

In another aspect of the present disclosure, a method for installing a diaphragm air seal between a cylindrical housing and a traction motor disposed therein is disclosed. The diaphragm air seal may include a first flange, a second flange, and an air seal body having an S-shaped transverse cross-section and extending between the first flange and the second flange. The method for installing a diaphragm air seal may include securing the first flange to the cylindrical housing to form a sealing engagement there between, manipulating the air seal body in at least a radial direction to allow the second flange to compress around the traction motor, and securing the second flange to the traction motor to form a sealing engagement there between.

In a further aspect of the present disclosure, an air seal assembly for providing an air seal between an outer cylindrical housing and a traction motor disposed therein is disclosed. The air seal assembly may include an annular air seal weldment and a diaphragm air seal. The air seal weldment may include a radial weldment flange having a first radial surface, a second radial surface disposed opposite the first radial surface, and an axial weldment flange extending axially outwardly from the second radial surface of the radial weldment flange. The diaphragm air seal may include a first flange dimensioned to slide onto the axial weldment flange and sealingly engage the axial weldment flange, a second flange dimensioned to received the traction motor within a circular opening of the second flange and to be compressed to sealingly engage the fraction motor, and an air seal body extending between the first flange and the second flange, the air seal body formed from an elastomeric material and having an S-shaped transverse cross-section.

Additional aspects are defined by the claims of this patent.

### BRIEF DESCRIPTION OF THE DRAWINGS

FIG. 1 is an isometric partial cut-away view showing an axle box, a traction motor disposed within the axle box, and a diaphragm air seal disposed between the axle box and the traction motor;

FIG. 2 is a front view of a diaphragm air seal in accordance with the present disclosure appropriate for installation as shown in FIG. 1;

FIG. 3 is a cross-sectional view taken through line 3-3 of the diaphragm air seal of FIG. 2;

FIG. 4 is an enlarged view of a portion of the diaphragm air seal of FIG. 2 identified as Detail 4;

FIG. 5 is a cross-sectional view of an annular air seal weldment of the axle box of FIG. 1;

FIG. 6 is a cross-sectional view of the diaphragm air seal of FIG. 2 partially installed between the axle box and traction motor of FIG. 1;

FIG. 7 is a cross-sectional view of the diaphragm air seal of FIG. 2 completely installed between the axle box and traction motor of FIG. 1;

FIG. 8 is a cross-sectional view of the diaphragm air seal of FIG. 2 partially installed between the axle box and cylindrical body of FIG. 1 and with the traction motor partially inserted through the diaphragm air seal and radially offset from a longitudinal axis of the axle box;

FIG. 9 is a cross-sectional view of the diaphragm air seal of FIG. 2 completely installed between the axle box and traction motor of FIG. 1 and with the traction motor radially offset from a longitudinal axis of the axle box;

FIG. 10 is a cross-sectional view of a portion of the diaphragm air seal of FIG. 2 diametrically opposite the portion of the diaphragm air seal of FIG. 9; and

FIG. 11 is a flow diagram of an installation process routine for installing the diaphragm air seal of FIG. 2 between the axle box and the traction motor of FIG. 1.

### DETAILED DESCRIPTION

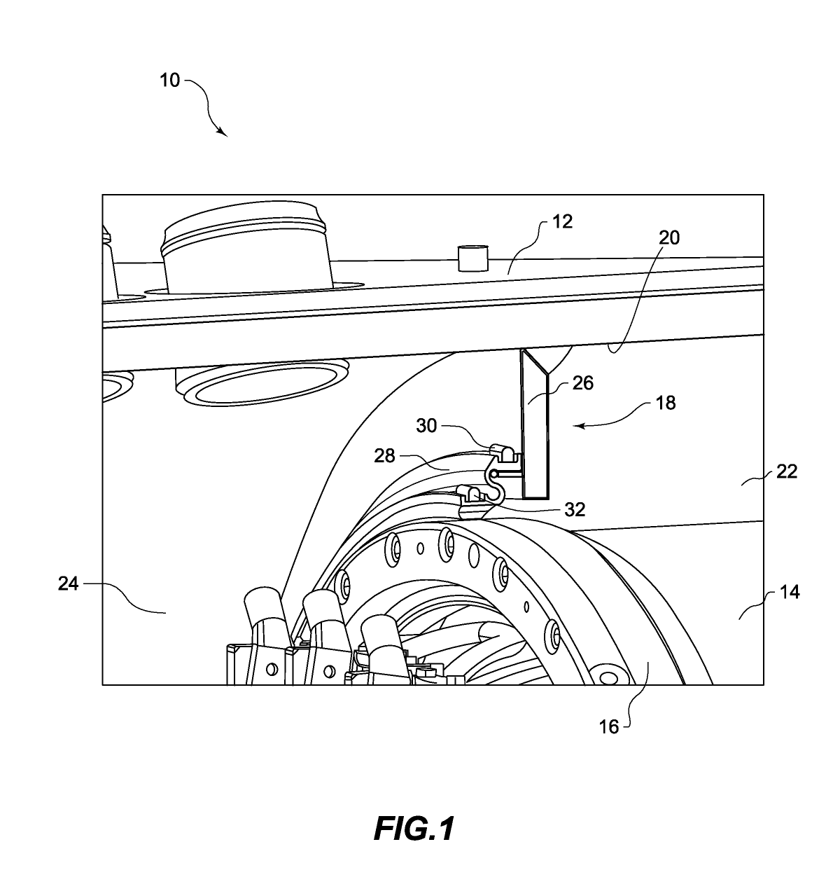

FIG. 1 illustrates an exemplary hollow cylindrical housing and cylindrical body assembly 10 in which a diaphragm air seal in accordance with the present disclosure may be implemented. The assembly 10 may be, for example, a hollow cylindrical housing 12 in the form of an axle box for a work machine that houses a traction motor 14 that drives axle shafts to provide power to traction devices of the work machine. The traction motor 14 may have a cylindrical body 16 enclosing a rotor and a stator (not shown) of the traction motor 14, and a drive shaft (not shown) extending there from. When installed, the cylindrical body 16 and the drive shaft may be approximately concentrically aligned with the cylindrical housing 12 about a longitudinal axis of the cylindrical housing 12.

The assembly 10 may be provided with an annular air seal assembly 18 in accordance with the present disclosure extending between the cylindrical housing 12 and the cylindrical body 16 that may divide an interior of the cylindrical housing 12 defined by a housing inner surface 20 into an inlet or high pressure cavity 22 and an outlet or low pressure cavity 24. The air seal assembly 18 may include an annular air seal weldment 26 attached to and extending radially inwardly from the housing inner surface 20, and a diaphragm air seal 28 that may, when installed, provide a seal sufficient to substantially contain air within the high pressure cavity 22 so that the air may be retained within the high pressure cavity 22 and flow through the traction motor 14 to the low pressure cavity 24 to cool off the traction motor 14 as the motor 14 operates to provide power to the traction devices. The annular weldment 26 may provide a first point of attachment for the diaphragm air seal 28, and the cylindrical body 16 of the motor 14 may provide a second point of attachment for the diaphragm air seal 28 to substantially cut off air flow between the high pressure cavity 22 and the low pressure cavity 24. The diaphragm air seal 28 may be secured to the weldment 26 by a first or large inner diameter clamp 30, and to the cylindrical body 16 by a second or small inner diameter clamp 32 in a manner described more fully below.

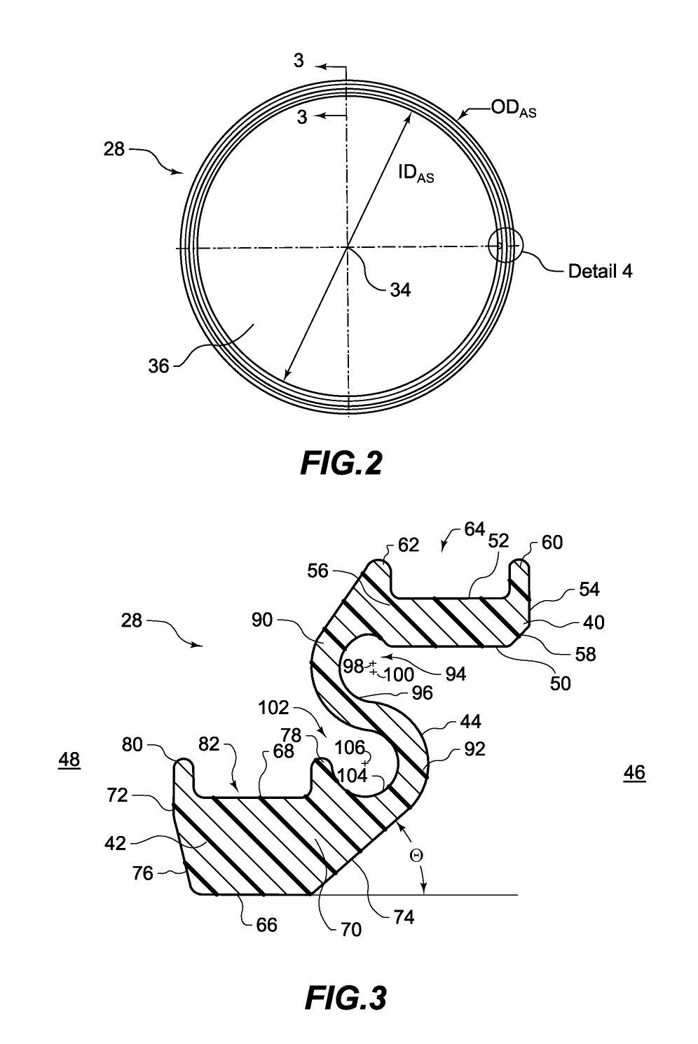

The structure of the diaphragm air seal 28 is shown in greater detail in FIGS. 2-4. Referring to FIG. 2, the diaphragm air seal 28 may be approximately circular and centered about a center or longitudinal axis 34. The diaphragm air seal 28 may be formed from rubber or other appropriate elastomeric material that may allow deformation of the diaphragm air seal 28 as necessary for attachment between the weldment 26 and the motor body 16 when the cylindrical housing 12 and the traction motor 14 are not perfectly coaxially aligned. The diaphragm air seal 28 may have a circular opening 36 there through having an air seal inner diameter ID_{AS} that is greater than an outer diameter of the motor body so that the motor body 16 may be inserted through the circular opening 36 during installation of the motor 14 within the cylindrical housing 12 with minimal to no resistance when the motor 14 and the diaphragm air seal 28 are coaxially aligned. The diaphragm air seal 28 may also have an air seal outer diameter OD_{AS} defining a maximum outward extent of the diaphragm air seal 28.

FIG. 3 shows the cross-sectional shape of the diaphragm air seal 28 in its normal, non-deformed configuration. It should be understood that the diaphragm air seal 28 has a substantially similar configuration about their entire circumference such that a cross-sectional view taken through another plane intersecting the center 34 of the diaphragm air seal 28 would be substantially similar except as noted hereinafter. The diaphragm air seal 28 may include a first annular flange 40 having a first flange inner diameter, a second annular flange 42 having a second flange inner diameter that is less than the first flange inner diameter, and a diaphragm air seal body 44 connecting the first annular flange 40 to the second annular flange 42 and having an S-shaped cross-section. The first annular flange 40 extends axially approximately parallel to the longitudinal axis 34 between a first or high pressure cavity side 46 and a second or low pressure cavity side 48 of the diaphragm air seal 28. The designations of the high pressure cavity side 46 and the low pressure cavity side 48 are provided as references for the respective sides of the diaphragm air seal 28 and the weldment 26 as discussed further below, and the spatial relationships of the components when installed within the assembly 10. It should be noted, however, that diaphragm air seals 28 in accordance with the present disclosure may be implemented in other assemblies having a cylindrical body installed within a hollow cylindrical housing to divide the space between an inner surface of the housing and the outer surface of the cylindrical body.

The first annular flange 40 may include a first axial sealing surface 50 facing inwardly toward the longitudinal axis 34, a first clamp engagement surface 52 facing outwardly from the longitudinal axis 34, a first radial end surface 54 facing the first side 46, and a first point of intersection 56 with the diaphragm air seal body 44 opposite the first radial end surface 54. The first axial sealing surface 50 may be configured to face and engage a corresponding surface of the weldment 26 and form a seal there between, and have an inner diameter dimensioned to interact with the weldment 26 during installation in a manner described more fully below. To further facilitate installation of the first annular flange 40 on the weldment 26, a first beveled surface 58 may be formed at an intersection of the first axial sealing surface 50 and the first radial end surface 54. The first clamp engagement surface 52 may be configured to face and engage a corresponding inner surface of the first clamp 30 when the first clamp 30 is installed thereon. To aid in retention and alignment of the first clamp 30 and the first clamp engagement surface 52, the first annular flange 40 may further include a first radially extending lip 60 proximate the first radial end surface 54 and a second radially extending lip 62 proximate the first point of intersection 56. The first clamp engagement surface 52 and the radially extending lips 60, 62 may define a first clamp receiving channel 64 within which the first clamp 30 may be disposed and retained during installation of the air seal assembly 18.

The second annular flange 42 may also extend axially approximately parallel to the longitudinal axis 34 between the high pressure cavity side 46 and the low pressure cavity side 48 of the diaphragm air seal 28. The second annular flange 42 may include a second axial sealing surface 66 facing inwardly toward the longitudinal axis 34, a second clamp engagement surface 68 facing outwardly from the longitudinal axis 34, a second point of intersection 70, and a second radial end surface 72 opposite the second point of intersection 70 and facing the second side 48. The second axial sealing surface 66 may have the air seal inner diameter ID_{AS} as discussed above to receive the motor body 16 and engage the motor body 16 when the second clamp 32 is applied to form a seal there between.

During some installations, the traction motor 14 may not be coaxially aligned with the cylindrical housing 12, and the motor body 16 may engage the diaphragm air seal 28 as it is inserted in the axial direction through the circular opening 36 of the diaphragm air seal 28. To minimize resistance to the movement of the motor body 16 and to prevent damage to the diaphragm air seal 28 during installation, the second annular flange 42 may be provided with an angled camming surface 74 at the second point of intersection 70. The camming surface 74 may extend radially outwardly from intersection of the second point of intersection 70 and the second axial sealing surface 66 and axially away from the second point of intersection 70 and toward the first side 46 at an angle θ relative to the longitudinal axis 34. The angle θ may have an appropriate value that is greater than 0° and less than 90°, and may be within the range from 30° to 60°. In one exemplary embodiment, the angle θ may have a value approximately equal to 41.8° and interact with the motor body 16 in a manner illustrated and described more fully below. At the second side 48, the second radial end surface 72 may extend radially from the second clamp engagement surface 68 to the second axial sealing surface 66. Alternatively, as shown in FIG. 3, the second annular flange 42 may have a second beveled surface 76 that extends radially from the second radial end surface 72 toward the second axial sealing surface 66 and axially toward the second point of intersection 70 until intersecting with the second axial sealing surface 66. The second beveled surface 76 may reduce the amount of material required for the diaphragm air seal 28 and, correspondingly, reduce the cost and weight of the diaphragm air seal 28 and the installation time for the assembly 10.

The second clamp engagement surface 68 may be configured to face and engage a corresponding inner surface of the second clamp 32 when the second clamp 32 is installed thereon. To aid in retention and alignment of the second clamp 32 and the second clamp engagement surface 68, the second annular flange 42 may further include a first radially extending lip 78 proximate the second point of intersection 70 and a second radially extending lip 80 proximate the second radial end surface 72. The second clamp engagement surface 68 and the radially extending lips 78, 80 may define a second clamp receiving channel 82 within which the second clamp 32 may be disposed and retained during installation of the air seal assembly 18.

The air seal body 44 extends between the first point of intersection 56 of the first annular flange 40 and the second point of intersection 70 of the second annular flange 42. The air seal body 44 may include a first seal body portion 90 and a second seal body portion 92. The first seal body portion 90 may extend toward the second side 48 from the first point of intersection 56 and then curve back toward the first side 46 until intersecting with the second seal body portion 92. Consequently, the first seal body portion 90 may have a first annular opening 94 facing toward the first side 46. A first inner surface 96 of the first seal body portion 90 may have a curvature configured for a corresponding portion of the weldment 26 to be received through the first annular opening 94 and retained therein to prevent the first annular flange 40 from sliding off of the weldment 26. The curvature of the first inner surface 96 may be constant about a center of curvature. Alternatively, as shown in the illustrated embodiment, the first inner surface 96 may have a first center of curvature 98 proximate a point of intersection with the first axial sealing surface 50, and transition to a second center of curvature 100 as the first inner surface 96 extends toward the second seal body portion 92. In this configuration, a channel portion of the first inner surface 96 centered about the first center of curvature 98 may be disposed radially outwardly from the first axial sealing surface 50 for receipt of a corresponding portion of the weldment 26 during installation as will be illustrated and described in greater detail below.

The second seal body portion 92 may extend toward the first side 46 from the second point of intersection 70 and then curve back toward the second side 48 until intersecting with the first seal body portion 90. Configured in this way, the second seal body portion 92 may have a second annular opening 102 facing in the opposite direction as the first annular opening 94 and toward the second side 48. A second inner surface 104 of the second seal body portion 92 may have a curvature about a third center of curvature 106, though it is contemplated in alternative embodiments for the second inner surface 104 to have other non-circular curvatures that still provide the S-shaped cross-section of the air seal body 44.

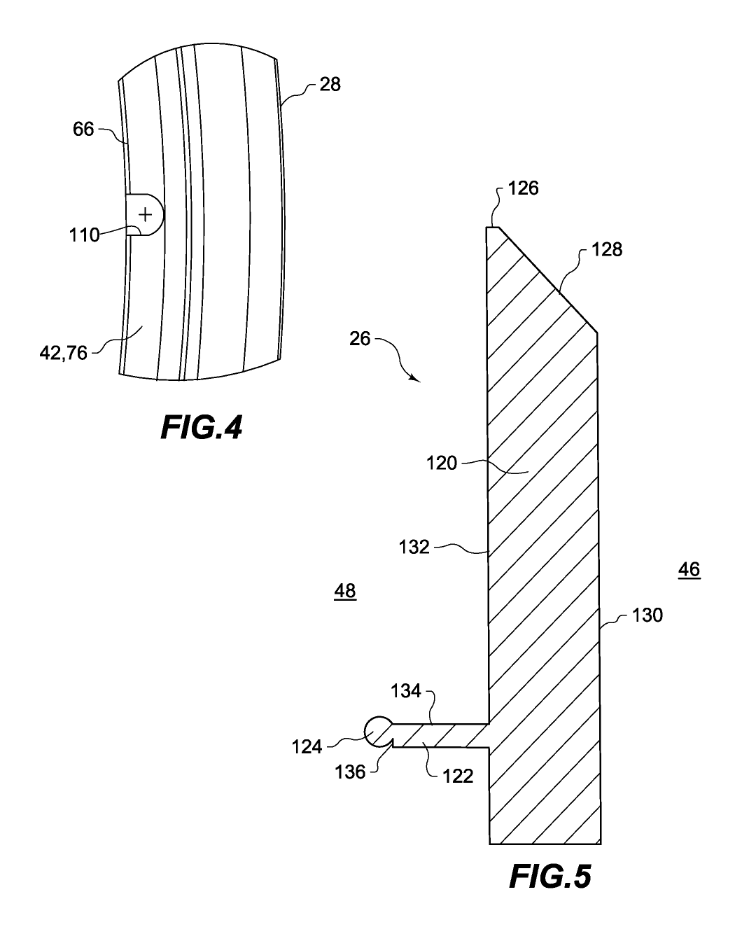

In some implementations, the traction motor 14 or other cylindrical body disposed within a cylindrical housing 12 may require one or more conduits external to the cylindrical body 16 to extend between the high pressure cavity 22 and the low pressure cavity 24. For example, with the traction motor 14, a grease line hose (not shown) may have to extend across the interface formed by the weldment 26 and the diaphragm air seal 28 to provide lubricant for the traction motor 14 and/or other components within the cylindrical housing 12. FIG. 4 illustrates an enlarged portion of the diaphragm air seal 28 in which an axially extending cutout 110 is formed through the second annular flange 42 to provide a location for passage of a conduit or conduits there through. The cutout 110 extends radially outwardly from the second axial sealing surface 66 and terminates radially inwardly from the second clamp engagement surface 68. The presence of the cutout 110 and the conduit extending there between may prevent the air seal assembly 18 from providing a completely airtight seal, but the seal may be sufficient to provide redirection of air within the high pressure cavity 22 with acceptable loss of air through the opening formed by the cutout 110.

The air seal assembly 18 further includes the weldment 26 extending radially inwardly from the housing inner surface 20 and configured for attachment of the first annular flange 40 thereto. As shown in FIG. 5, the weldment 26 may include a radial weldment flange 120, and axial weldment flange 122 and an annular weldment ring 124. The radial weldment flange 120 may include an outer housing facing surface 126 having an outer diameter that is close to but less than an inner diameter of the housing inner surface 20, and a beveled outer edge 128 extending from the outer housing facing surface 126 configured for forming a single fillet tee joint weld between the housing inner surface 20 and the outer periphery of the radial weldment flange 120. Of course, those skilled in the art will understand that the radial weldment flange 120 may be attached to the housing inner surface 20 by alternative attachment mechanisms, and welding is merely exemplary of such attachment mechanisms. The radial weldment flange 120 may further include a first radial surface 130 disposed on the first side 46 of the weldment 26, and an oppositely disposed second radial surface 132 disposed on the second side 48 of the weldment 26. The axial weldment flange 122 may extend axially from the second radial surface 132 of the radial weldment flange 120, and include an air seal engagement surface 134 on an outward side of the axial weldment flange 122. The air seal engagement surface 134 may have an outer diameter that is approximately equal to or greater than an inner diameter of the first axial sealing surface 50 so that the first axial sealing surface 50 faces and engages the air seal engagement surface 134 when the first annular flange 40 slides onto and around the axial weldment flange 122.

The annular weldment ring 124 may be attached to the axial weldment flange 122 at a flange end 136 disposed opposite the second radial surface 132 of the radial weldment flange 120. In the illustrated embodiment, the annular weldment ring 124 has a circular cross-section, and may have an outer diameter that is greater than the outer diameter of the air seal engagement surface 134 such that a portion of the annular weldment ring 124 is disposed radially outwardly from the air seal engagement surface 134. The outer diameter of the annular weldment ring 124 may also be greater than the inner diameter of the first axial sealing surface 50 to create an interfering relationship between the annular weldment ring 124 and the first axial sealing surface 50 that may facilitate retention of the first annular flange 40 on the axial weldment flange 122 after the first annular flange 40 is installed on the axial weldment flange 122 and when the first clamp 30 is not tightened around the first annular flange 40. The radial weldment flange 120, the axial weldment flange 122 and the annular weldment ring 124 may be fabricated as separate components of the air seal weldment 26 and subsequently fastened together via welding, adhesive or other appropriate attachment mechanism. Alternatively, the components of the air seal weldment 26 may be fabricated as a single unitary component ready for installation within the cylindrical housing 12.

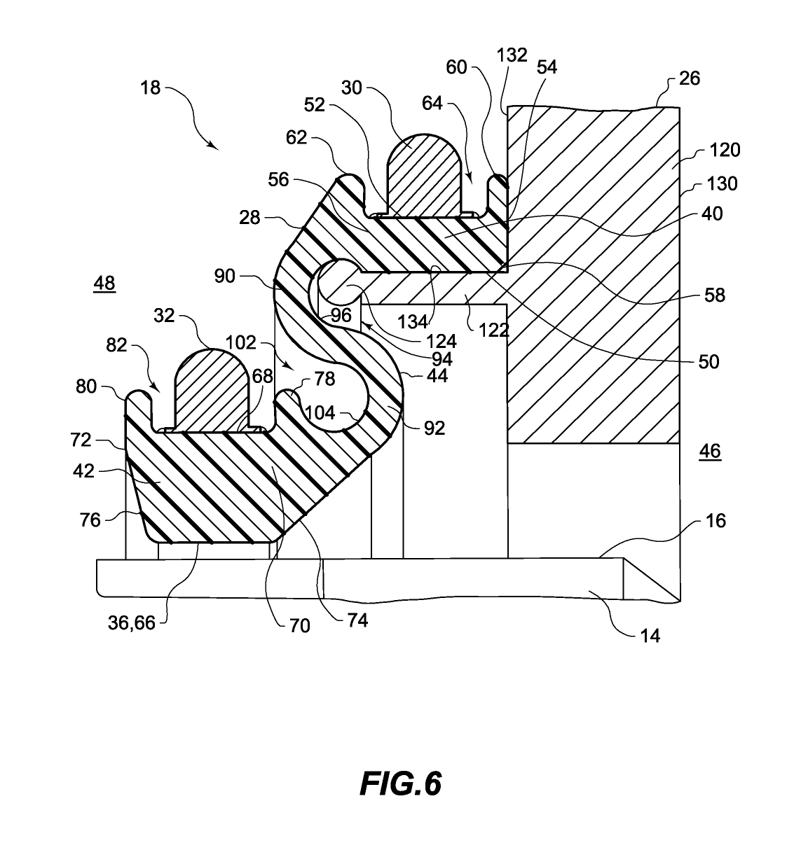

FIG. 6 illustrates the air seal assembly 18 with the diaphragm air seal 28 partially installed in the hollow cylindrical housing and cylindrical body assembly 10. At the illustrated point of the installation, the first annular flange 40 of the diaphragm air seal 28 is installed around the axial weldment flange 122 of the weldment 26, and the motor body 16 is been inserted through the circular opening 36 and the second axial sealing surface 66 of the diaphragm air seal 28, but with the second annular flange 42 not being tightened down around the motor body 16. When the first annular flange 40 is installed on the axial weldment flange 122, the interfering relationship between the first axial sealing surface 50 and the annular weldment ring 124 requires the first annular flange 40 to slide over the annular weldment ring 124. The first beveled surface 58 of the first annular flange 40 may be complementary to the annular weldment ring 124 so that the first annular flange 40 deflects radially outwardly in order to pass over the annular weldment ring 124 before returning toward its normal non-stretched condition around the axial weldment flange 122 so that the first axial sealing surface 50 faces and engages the air seal engagement surface 134. At the same time, the first inner surface 96 of the first seal body portion 90 engages the annular weldment ring 124 to substantially prevent the first annular flange 40 from sliding off of the axial weldment flange 122.

The first or large outer diameter clamp 30 as shown is installed around the first annular flange 40 and within the first clamp receiving channel 64 between the lips 60, 62. The first clamp 30 may be loosely installed around the first annular flange 40 before the first annular flange 40 is installed on the axial weldment flange 122, or the first clamp 30 may be installed after the first annular flange 40 is in position as shown in FIG. 6. Once the first annular flange 40 is installed, the first clamp 30 may be tightened around the first annular flange 40 to form a seal between the first axial sealing surface 50 and the air seal engagement surface 134. The second or small outer diameter clamp 32 as shown is installed around the second annular flange 42 and within the second clamp receiving channel 82 between the lips 78, 80. The second clamp 32 is installed around the second annular flange 42 but not tightened down around the second annular flange 42 so that the motor body 16 may be inserted through the circular opening 36. Because the second clamp 32 is not tightened and compressing the second annular flange 42 around the motor body 16, the air seal body 44 is not subjected to forces that would tend to cause the air seal body 44 to deflect. Consequently, the air seal body 44 retains its normal shape as previously shown in FIG. 3.

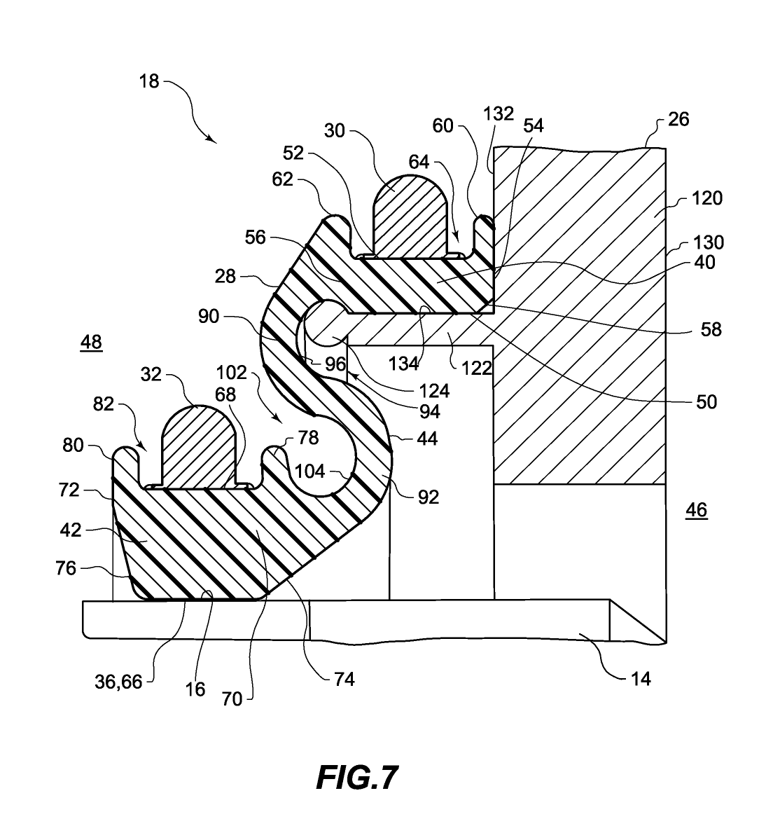

The complete installation of the air seal assembly 18 is shown in FIG. 7. With the first annular flange 40 installed on the axial weldment flange 122, and the motor body 16 inserted through the circular opening 36 of the diaphragm air seal 28, the second clamp 32 may be tightened to compress the second annular flange 42 down around the motor body 16. As the clamp 32 is tightened, the second axial sealing surface 66 closes around and engages the motor body 16 and forms a seal there between. As a second annular flange 42 is compressed and moves radially inwardly around the motor body 16, forces are applied to the second seal body portion 92 in the radially inward direction toward the longitudinal axis 34 of the diaphragm air seal 28. Because the first seal body portion 90 is retained at the point of connection with the first point of intersection 56 of the first annular flange 40, the elasticity of the diaphragm air seal 28 allows the first and second seal body portions 90, 92 to deflect radially inwardly to elongate the air seal body 44, thereby allowing the second axial sealing surface 66 to close around and engage the motor body 16.

### INDUSTRIAL APPLICABILITY

The installation illustrated and described in relation to FIGS. 6-7 is a typical installation wherein the cylindrical housing 12 and the traction motor 14 are substantially coaxially aligned and the motor body 16 is able to pass into the circular opening 36 without engaging the second annular flange 42 at the camming surface 74. However, in many installations the traction motor 14 is not aligned with the cylindrical housing 12 either during the installation process or after the traction motor 14 is installed within the cylindrical housing 12. In either misalignment situation, the S-shaped cross-section of the air seal body 44 allows the diaphragm air seal 28 to deform and accommodate the misalignment of the traction motor 14 without unduly restricting the insertion of the fraction motor 14 or compromising the seal formed between the second axial sealing surface 66 and the motor body 16.

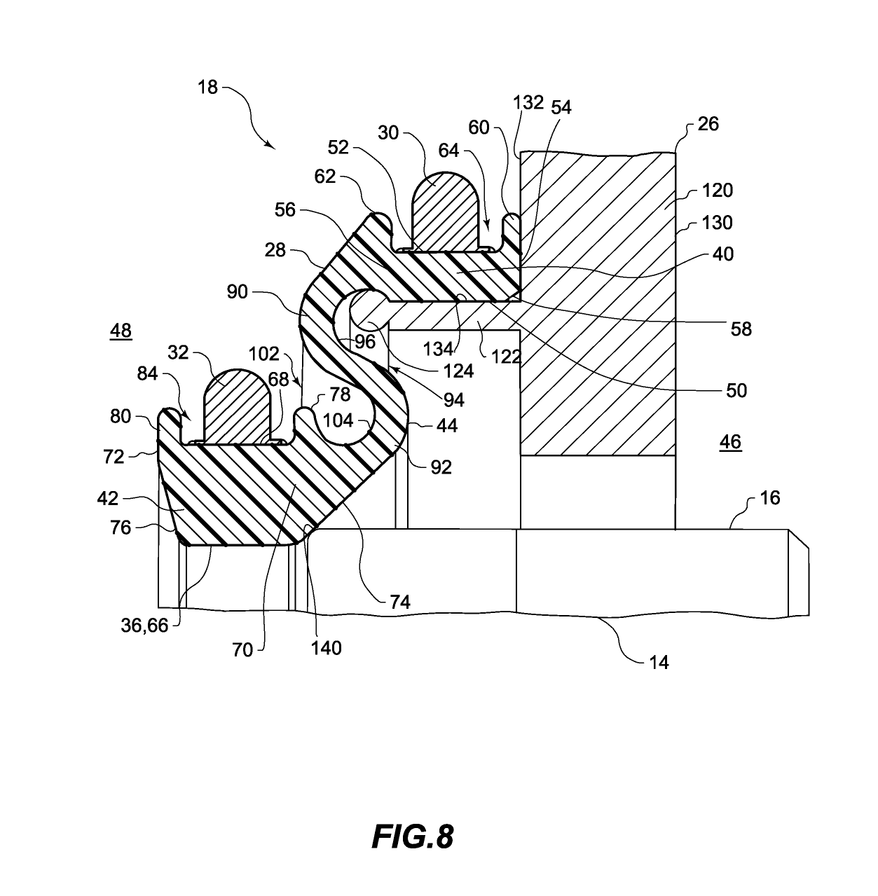

FIG. 8 illustrates a situation in which the traction motor 14 is not coaxially aligned with the cylindrical housing 12 when the traction motor 14 is inserted during installation. As the traction motor 14 moves axially to the left as shown in FIG. 8 toward the first side 46 of the diaphragm air seal 28, a portion of a leading edge 140 that is radially closest to the housing inner surface 20 comes into engagement with a corresponding portion of the camming surface 74 of the second annular flange 42. Due to friction between the camming surface 74 and the leading edge 140, the second annular flange 42 of the diaphragm air seal 28 is pushed toward the second side 48 by the motor body 16. As the second annular flange 42 is displaced, the air seal body 44 experiences a bending moment in the clockwise direction about the point of intersection of the first point of intersection 56 of the first annular flange 40 and the first seal body portion 90. The resiliency of the air seal body 44 allows the first seal body portion 90 and the second seal body portion 92 to deflect in response to the bending moment to allow the second annular flange 42 to move toward the second side 48. Eventually, the restorative force buildup in the air seal body 44 in the opposite direction of the bending moment is sufficient to overcome the frictional force between the camming surface 74 and the leading edge 140 of the motor body 16. When the frictional force is overcome by the restorative force, the camming surface 74 is able to slide over the leading edge 140 of the motor body 16 and allow the second annular flange 42 to move radially outwardly and axially toward the first side 46 and its normal axial position. At the same time, the motor body 16 continues to move toward the second side 48 and ultimately to its installed axial position. At that point, the second clamp 32 may be tightened around the second annular flange 42 to form the seal between the motor body 16 and the second axial sealing surface 66.

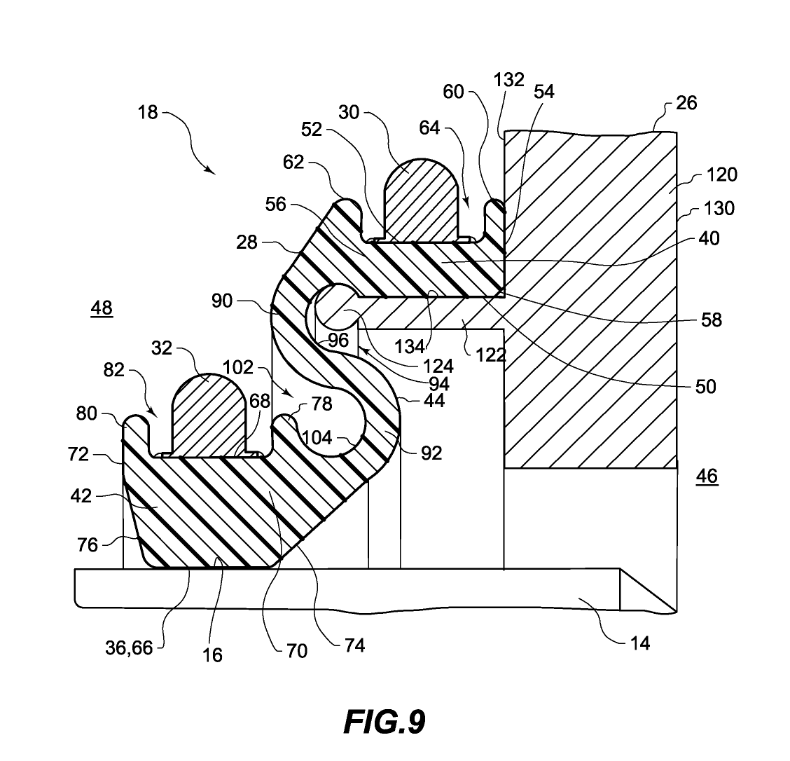

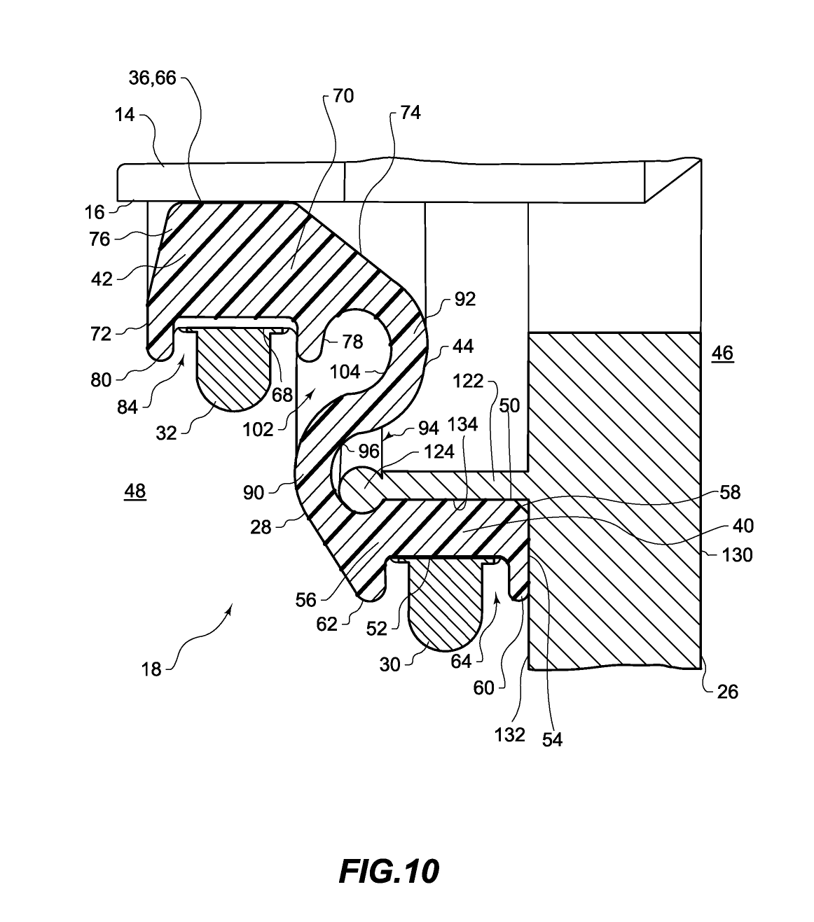

FIGS. 9 and 10 illustrate a completed implementation of an air seal assembly 18 where the traction motor 14 is offset from being coaxially aligned within the cylindrical housing 12. FIG. 9 shows a portion of the air seal assembly 18 where the tractor motor 14 is offset toward the housing inner surface 20. Because the motor body 16 is closer to the housing inner surface 20 than it is when the traction motor 14 is substantially coaxially aligned with the cylindrical housing 12 as shown in FIG. 7, the air seal body 44 is not deflected and elongated to the extent shown in FIG. 7, and may even be compressed between the first annular flange 40 and the second annular flange 42. As shown in FIG. 9, the air seal body 44 is minimally compressed or elongated, and has a cross-sectional shape substantially the same as the normal shape shown in FIGS. 3 and 6.

FIG. 10 shows the opposite side of the traction motor 14 and air seal assembly 18 wherein the motor body 16 is farther away from the housing inner surface 20 than in the substantially coaxially aligned installation shown in FIG. 7. As the elongation of the air seal body 44 is reduced as shown in FIG. 9, the air seal body 44 experiences greater elongation on the diametrically opposed opposite side shown in FIG. 10. However, the flexibility of the air seal body 44 of the diaphragm air seal 28 prevents the application of excessive radially outward forces on the second point of intersection 70 that may tend to compromise the seal formed between the second axial sealing surface 66 and the motor body 16 as may be formed in diaphragm air seals having less forgiving geometries.

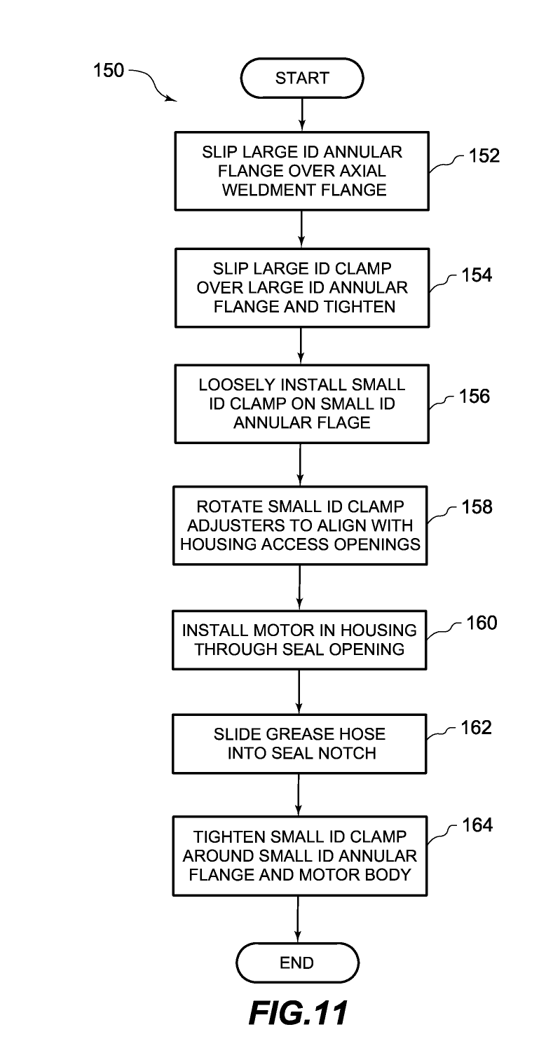

The arrangement of the air seal assembly 18 and the diaphragm air seal 28 may also facilitate assembly of the traction motor 14 within the cylindrical housing 12. Typically, space is at a premium in machines in which the assembly 10 may be installed, and it may be difficult to obtain access to prior air seal assemblies to tighten the air seal around a cylindrical body. FIG. 11 illustrates an exemplary air seal assembly installation routine 150 that may be executed by an installer to arrange the diaphragm air seal 28 between the weldment 26 and the motor body 16 of the traction motor 14. The installation routine 150 may begin at a block 152 wherein the first large inner diameter annular flange 40 is slipped over the axial weldment flange 122. As discussed above, when the first annular flange 40 is pressed onto the axial weldment flange 122, the first beveled surface 58 directs the first axial sealing surface 50 over and past the annular weldment ring 124. After the first annular flange 40 is installed on the axial weldment flange 122, control may pass to a block 154 where the first large inner diameter clamp 30 is slipped over the first annular flange 40 and into the first clamp receiving channel 64, and the first clamp 30 is tightened around the first annular flange 40. In alternate installation routines, the first clamp 30 may be loosely slipped onto the first annular flange 40 before the first annular flange 40 is slipped onto the axial weldment flange 122, and then tightened after the first annular flange 40 is slipped onto the axial weldment flange 122.

With the first annular flange 40 installed and tightened to form a seal between the first axial sealing surface 50 and the air seal engagement surface 134, control may pass to a block 156 where the second small inner diameter clamp 32 is loosely installed on the second small inner diameter annular flange 42, and then to a block 158 where the second clamp 32 is rotated about the second clamp engagement surface 68 to position clamp adjusters (not shown) of the second clamp 32 into alignment with corresponding access openings (not shown) through the wall of the cylindrical housing 12 for improved access later in the installation routine 150. The second clamp 32 is installed loosely to allow insertion of the traction motor 14 through the circular opening 36 of the diaphragm air seal 28 at a block 160.

Where a conduit such as a grease hose will traverse the air seal assembly 18, the grease hose is inserted through the circular opening 36 of the diaphragm air seal 28 along with the traction motor 14. However, the conduit may not be aligned with the seal cutout 110 in the second annular flange 42 of the diaphragm air seal 28. Consequently, where the conduit is not aligned with the seal cutout 110, control may pass to a block 162 where an installer may slide the grease hose or other conduit into the seal cutout 110 so that the second axial sealing surface 66 may face and be capable of completely engaging the surface of the motor body 16. With the final obstacle to sealing off the high pressure cavity 22 from the low pressure cavity 24 removed, control may pass to a block 164 where the installer may tighten the second small inner diameter clamp 32 around the second small inner diameter annular flange 42 and the motor body 16 to form a seal between the second axial sealing surface 66 and the motor body 16.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A diaphragm air seal for providing a seal between an outer cylindrical housing and a traction motor disposed therein, the diaphragm air seal comprising:
a first flange having a first sealing surface for sealingly engaging with the outer cylindrical housing;
a second flange having a second sealing surface for sealingly engaging with the traction motor; and
an air seal body extending between the first flange and the second flange, the air seal body being formed from an elastomeric material and having an S-shaped transverse cross-section.

2. The diaphragm air seal according to claim 1, wherein the first flange extends from a first radial end surface proximate a first side of the diaphragm air seal to a first point of intersection with the air seal body proximate a second side of the diaphragm air seal, the second flange extends from a second radial end surface proximate the second side of the diaphragm air seal to a second point of intersection with the air seal body proximate the first side of the diaphragm air seal.

3. The diaphragm air seal according to claim 2, wherein the first flange comprises:
a first clamp engagement surface disposed opposite the first sealing surface;
a first radially extending lip extending radially outwardly from the first flange proximate the first radial end surface; and
a second radially extending lip extending radially outwardly from the first flange proximate the first point of intersection with the air seal body, wherein the first clamp engagement surface, the first radially extending lip and the second radially extending lip define a first clamp receiving channel for receiving a first clamp therein.

4. The diaphragm air seal according to claim 2, wherein the air seal body comprises:
a first curved seal body portion extending from the first point of intersection with the air seal body of the first flange and having a first annular opening facing toward the first side of the diaphragm air seal; and
a second curved seal body portion extending from the second point of intersection with the air seal body of the second flange and having a second annular opening facing toward the second side of the diaphragm air seal, and wherein the first curved seal body portion intersects the second curved seal body portion.

5. The diaphragm air seal according to claim 4, wherein a first inner surface of the first curved seal body portion has a channel portion thereof disposed radially outwardly from a first axial sealing surface of the first flange.

6. The diaphragm air seal according to claim 2, wherein the first flange comprises a beveled surface formed at an intersection of the first radial end surface and the first sealing surface of the first flange and extending radially outwardly from the first sealing surface and axially toward the first side of the diaphragm air seal.

7. The diaphragm air seal according to claim 2, wherein the second flange comprises a camming surface extending from an intersection of the second point of intersection and the second sealing surface of the second flange and radially outwardly and axially toward the first side of the diaphragm air seal.

8. The diaphragm air seal according to claim 1, comprising a cutout extending axially through the second flange at the second sealing surface for receiving a conduit there through.

9. A method for installing a diaphragm air seal between a cylindrical housing and a traction motor disposed therein, the diaphragm air seal including a first flange, a second flange, and an air seal body having an S-shaped transverse cross-section and extending between the first flange and the second flange, the method for installing the diaphragm air seal comprising:
securing the first flange to the cylindrical housing to form a sealing engagement there between;
manipulating the air seal body in at least a radial direction to allow the second flange to compress around the traction motor; and
securing the second flange to the traction motor to form a sealing engagement there between.

10. The method for installing a diaphragm air seal according to claim 9, wherein securing the first flange comprises:
slipping the first flange of the diaphragm air seal over an axial weldment flange, and
tightening a first clamp around the first flange and the axial weldment flange to form the sealing engagement there between;
wherein securing the first flange comprises tightening a second clamp around the second flange and the traction motor to form the sealing engagement there between; and
wherein the method for installing the diaphragm air seal comprises inserting the fraction motor through a circular opening formed by the second flange after tightening the first clamp around the first flange.

11. The method for installing a diaphragm air seal according to claim 10, comprising installing the first clamp over a first clamp engagement surface of the first flange before slipping the first flange over the axial weldment flange.

12. The method for installing a diaphragm air seal according to claim 10, comprising installing the second clamp over the second flange before inserting the fraction motor through the circular opening of the second flange.

13. The method for installing a diaphragm air seal according to claim 10, wherein the traction motor includes a conduit attached thereto that extends from a first side of the diaphragm air seal to a second side of the diaphragm air seal after the diaphragm air seal is installed, and wherein the diaphragm air seal comprises a cutout through the second flange for receiving the conduit there through, the method for installing the diaphragm air seal comprising aligning the conduit within the cutout before tightening the second clamp around the second flange.

14. The method for installing a diaphragm air seal according to claim 10, comprising orienting at least one tightening mechanism of the second clamp with a corresponding at least one access opening through the cylindrical housing before inserting the traction motor through the circular opening of the second flange.

15. An air seal assembly for providing an air seal between an outer cylindrical housing and a traction motor disposed therein, the air seal assembly comprising:
an annular air seal weldment comprising:
a radial weldment flange having a first radial surface, a second radial surface disposed opposite the first radial surface, and
an axial weldment flange extending axially outwardly from the second radial surface of the radial weldment flange;
a diaphragm air seal comprising:
a first flange dimensioned to slide onto the axial weldment flange and sealingly engage the axial weldment flange,
a second flange dimensioned to received the traction motor within a circular opening of the second flange and to be compressed to sealingly engage the traction motor, and
an air seal body extending between the first flange and the second flange, the air seal body formed from an elastomeric material and having an S-shaped transverse cross-section.

16. The air seal assembly according to claim 15, wherein the first flange extends from a first radial end surface proximate a first side of the diaphragm air seal to a first point of intersection with the air seal body proximate a second side of the diaphragm air seal, the second flange extends from a second radial end surface proximate the second side of the diaphragm air seal to a second point of intersection with the air seal body proximate the first side of the diaphragm air seal, and wherein the first flange slides onto the axial weldment flange by sliding the first radial end surface past a flange end of the axial weldment flange opposite the second radial surface of the radial weldment flange.

17. The air seal assembly according to claim 16, wherein the annular air seal weldment comprises an annular weldment ring attached at the flange end of the axial weldment flange, and the annular weldment ring has a ring outer diameter that is greater than a first flange inner diameter.

18. The air seal assembly according to claim 17, wherein the first flange comprises a beveled surface formed at an intersection of the first radial end surface and a first sealing surface of the first flange and extending radially outwardly from the first sealing surface and axially toward the first side of the diaphragm air seal.

19. The air seal assembly according to claim 17, wherein the air seal body comprises:
a first curved seal body portion extending from the first point of intersection of the first flange and having a first annular opening facing toward the first side of the diaphragm air seal, wherein a first inner surface of the first curved seal body portion has a channel portion thereof disposed radially outwardly from a first sealing surface of the first flange such that the annular weldment ring is disposed therein when the first flange is installed around the axial weldment flange; and
a second curved seal body portion extending from the second point of intersection of the second flange and having a second annular opening facing toward the second side of the diaphragm air seal.

20. The air seal assembly according to claim 16, wherein the second flange comprises a camming surface extending from an intersection of the second point of intersection and a second sealing surface of the second flange and radially outwardly and axially toward the first side of the diaphragm air seal.
